(19) United States
(12) Patent Application Publication
(10) Pub. No.: US 2002/0166989 A1
(43) Pub. Date: Nov. 14, 2002

(54) Valve assembly

(76) Inventor: Michael J. Peterson, Nashville, TN (US)

Correspondence Address: Lucian Wayne Beavers, Waddey & Patterson, Bank of America Plaza, Suite 2020, 414 Union Street, Nashville, TN, 37219, US

(21) Appl. No.: 10/114,162

(22) Filed: Apr. 2, 2002

Related U.S. Application Data
(60) Provisional application No. 60/289,428, filed on May 8, 2001.

(51) Int. Cl. F16K 5/10

(52) U.S. Cl. 251/208

(57) ABSTRACT

A valve assembly apparatus includes a Tee-fitting and a rotary valve. The Tee-fitting has first and second end openings and a third side opening. The rotary valve has a rotational axis extending laterally relative to the end openings. The rotary valve includes a first portion connected to the third side opening, and a rotatable portion. The rotatable portion is rotatable between open and closed positions. Intermediate positions define a metering function of the rotary valve. A shutoff function can also be provided.

This is a U.S. Patent Application filed by Michael J. Peterson, of Nashville, Tennessee, for the invention of a “Valve Assembly.” This application claims benefit of pending provisional application Serial No. 60/289,428 titled “Valve Assembly” filed May 8, 2001, the details of which are incorporated herein by reference.

### BACKGROUND OF THE INVENTION

1. Field of the Invention

The present invention relates generally to the field of pipe fittings and valves, and more particularly, but not by way of limitation, to such apparatus that are particularly suited for use in plumbing systems for a healthcare facility such as a dialysis clinic.

2. Description of the Prior Art

Traditionally, the plumbing systems for healthcare facilities have been permanent fixtures built as part of a building and including piping located within the walls of the building.

More recently, modular piping systems for use in healthcare facilities, and particularly in dialysis clinics, have been proposed, such as are shown in U.S. Pat. No. 6,197,197, the details of which are incorporated herein by reference.

There is, however, a continuing need for further improvements in such systems, and particularly for improvements in the fittings and valves utilized for such piping systems so as to simplify the systems and provide for improved operation thereof.

### SUMMARY OF THE INVENTION

In a first embodiment, the present invention provides an in-line valve assembly apparatus including a Tee-fitting and a rotary valve. The Tee-fitting has first and second in-line openings, and a third side opening. The rotary valve includes a fixed portion connected to the third side opening of the Tee-fitting, and fixed relative to the Tee-fitting. The rotary valve further includes a rotatable portion which is rotatable about a rotational axis, between open and closed positions.

The rotary valve may function as both a shutoff valve and a metering valve, or it can be designed to provide either of those functions alone.

In another embodiment of the invention, a quick connect valve apparatus includes first and second valve parts, with a quick connect fitting attached to the second valve part. The first and second valve parts are rotatably connected together so that the second valve part is rotatable about a rotational axis relative to the first valve part. First and second ports are defined in the first and second valve parts, respectively, each of the ports being radially offset from the rotational axis, so that rotational movement of the second valve part relative to the first valve part moves the second port into and out of registry with the first port.

Accordingly, it is an object of the present invention to provide improved piping assemblies for use in healthcare facilities.

Another object of the present invention is the provision of an in-line valve assembly including a Tee-fitting and a rotary valve connected to a side opening of the Tee-fitting.

And another object of the present invention is the provision of improved rotary shutoff valves.

Still another object of the present invention is the provision of improved rotary metering valves.

Still another object of the present invention is the provision of a pipe fitting and valve assembly in which an integral valve may be shut to allow a quick connect fitting to be removed from the assembly without interrupting a primary flow of fluid through the assembly.

Other and further objects, features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a schematic sectioned view of a Tee-fitting with a rotary valve connected thereto, all mounted on a mounting plate.

FIG. 2 is a sectioned view taken along line 2-2 of FIG. 1, illustrating a stop pin arrangement which limits movement of the rotary valve.

FIG. 3 is an elevation sectioned view similar to FIG. 1, showing an alternative construction for the rotary valve.

FIG. 4 is a sectioned view again similar to FIG. 1 and showing still another alternative embodiment of the rotary valve.

FIG. 5 is a sectioned view taken along line 5-5 of FIG. 1, illustrating the orientation of the ports in the valve.

FIG. 6 is an elevation view of the needle valve element of the rotary valve of FIG. 4.

FIG. 7 is a section view taken along line 7-7 of FIG. 4, showing guide groove and guide tab arrangement.

FIG. 8 is an elevation sectioned view showing a plurality of fittings like those of the previous figures, mounted together to form a manifold in a wall mounted housing, so as to provide a piping system for a healthcare facility.

FIG. 9 is an elevation view of another embodiment of the Tee-fitting and rotary valve assembly.

FIG. 9A is a schematic drawing of the embodiment of FIG. 9, with the addition of a separate shut-off valve.

FIG. 10 is a plan view of the fitting body of FIG. 9.

FIG. 11 is a section view of the fitting body of FIG. 10 taken line 11-11 of FIG. 10.

FIG. 12 is a perspective view of the fitting body of FIG. 10.

FIG. 13 is a end view of the fitting body of FIG. 10.

FIG. 14 is an elevation view of the fixed valve part of the assembly of FIG. 9.

FIG. 15 is a sectioned view of the fixed valve part of FIG. 14.

FIG. 16 is a plan view of the fixed valve part of FIG. 14.

FIG. 17 is an elevation view of the rotary valve part of the assembly of FIG. 9.

FIG. 18 is a sectioned elevation view of the rotary valve part of FIG. 17.

FIG. 19 is a plan view of the rotary valve part of FIG. 17.

FIG. 20 is a perspective view of the rotary valve part of FIG. 17.

### DETAILED DESCRIPTION OF THE PREFERRED EMBODIMENTS

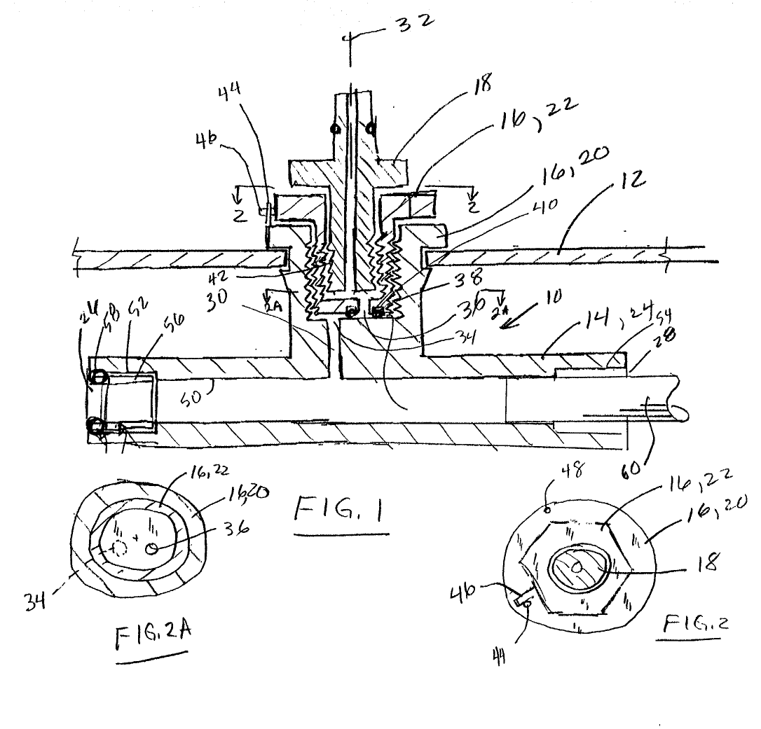

Referring now to the drawings, and particularly to FIG. 1, an in-line valve assembly apparatus is shown and generally designated by the numeral 10, wherein it is mounted in a mounting plate 12.

The apparatus 10 includes a Tee-fitting 14, a rotary valve 16, and a quick connect member 18. In this embodiment, the rotary valve 16 includes a fixed portion or fixed valve part 20 which is integrally formed with the Tee-fitting 14, and a rotatable portion or rotatable valve part 22.

The Tee-fitting 14 includes a cylindrical main fitting body 24 having first and second in-line openings 26 and 28, and a third side opening 30. Openings 26 and 28 may also be referred to as end openings 26 and 28.

The rotary valve 16 has a central axis or rotational axis 32 extending laterally relative to the in-line openings 26 and 28.

As previously noted, the rotary valve 16 has a fixed portion 22 which can be described as connected to the third side opening 30 and fixed relative to the Tee-fitting 14. As previously noted, in the embodiment of FIG. 1, the fixed portion 20 of rotary valve 16 is integrally formed with the cylindrical body 24 of Tee-fitting 14, but as shown below with regard to other embodiments, the fixed portion of the rotary valve may be formed separate from the Tee-fitting and the two connected together by a threaded engagement or the like.

The rotatable portion 22 of rotary valve 16 is rotatable about the central axis 32 relative to the fixed portion 20.

The fixed portion 20 can be described as having a first port 34 defined therein, which first port 34 is communicated with the side opening 30. The rotatable portion 22 has a second port 36 defined therein.

The first and second ports 34 and 36 are each radially offset from the rotational axis 32. In the view of FIG. 1, the ports 34 and 36 are out of registry with each other, thus defining a closed position of the valve 16. An O-ring 38 is received in a groove 40 defined in the lower end of rotatable member 22 around port 36 so as to provide a seal 38 which provides fluid isolation of the first port 34 from the second port 36 when the rotatable valve 16 is in its closed position as illustrated in FIG. 1.

Thus, when the rotary valve 16 is in its closed position, the seal 38 completely prevents flow between the ports 34 and 36, so that the rotary valve 16 functions as a shutoff valve. This will allow the quick connect member 18 to be removed from the rotary valve 16 without disrupting flow through the inline openings 26 and 28 of the Tee-fitting 14.

A partially sectioned plan view taken along line 5-5 shows the relative positions of first port 34 and second port 36 in the view of FIG. 1. When the rotatable portion 22 is rotated 90° clockwise, as seen in FIG. 5, relative to the fixed valve portion 20, the second port 36 will be located directly above and in complete registry with the first port 34 thus defining an open position of the valve 16. It will also be appreciated, that when the second port 36 is in partial registry with the first port 34, the valve 16 will be in a partially open position, and the degree of overlap of second port 36 with first port 34 provides a metering effect so that rotary valve 16 can function as both a shutoff valve and a metering valve. This can be described as moving the rotatable valve portion 22 through a plurality of intermediate positions relative to the fixed valve portion 20, wherein the first and second ports 34 and 36 are in partial registry to varying degrees, so that the rotary valve 16 can selectively meter flow through the third side opening 30.

The quick connect member 18 is threadedly connected to rotary valve portion 22 at threaded connection 42. The quick connect member 18 may be any suitable quick connect member, and in the illustrated embodiment quick connect member 18 is a male portion of a standard PLC Series quick connect available from Colder Products.

As seen in FIGS. 1 and 2, the first pin 44 extends from the fixed valve portion 20, and a second pin 46 extends from the rotatable valve portion 22. The first and second pins 44 and 46 may be described as complementary first and second abutment surfaces 44 and 46. The pins 44 and 46 abut each other in the view of FIG. 2 to terminate relative rotational motion between the fixed and rotatable valve portions 20 and 22 at a position corresponding to the closed position of valve member 16 shown in FIG. 1. When rotatable valve portion 22 is rotated 90° clockwise, as seen in FIG. 2, relative to the fixed valve portion 20, the pin 46 will abut another pin 48 to define the fully open position of valve member 16.

Each of the first and second in-line openings 26 and 28 of fitting body 24 is defined by an axial bore 50 which extends through the cylindrical body 24. Counter bores 52 and 54 are defined in each end of the valve body, and may receive Teflon bushings 56 and O-rings 58 for sealing against a pipe such as 60 which will be inserted into each of the in-line openings 26 and 28. In FIG. 1, only the bushing 56 and O-ring 58 are shown adjacent the first opening 26, and only the pipe member 60 is shown within the second opening 28, so as to better illustrate each of those individual components.

The associated pipe member such as pipe 60 will be received in the first and second openings of their associated tee-fittings and will extend past the sealing members thereof. The seals will be located within the openings 26 and 28 and the pipe member 60 will extend into those openings by a distance extending beyond the seals by an amount sufficient to accommodate thermal expansion and contraction of the pipe member 60. Thus the pipe members 60 remain received within the openings 26 and 28 and remain sealingly engaged with their associated Tee-fittings 10 during any anticipated amount of thermal expansion and contraction or other physical movement of the pipe member 60.

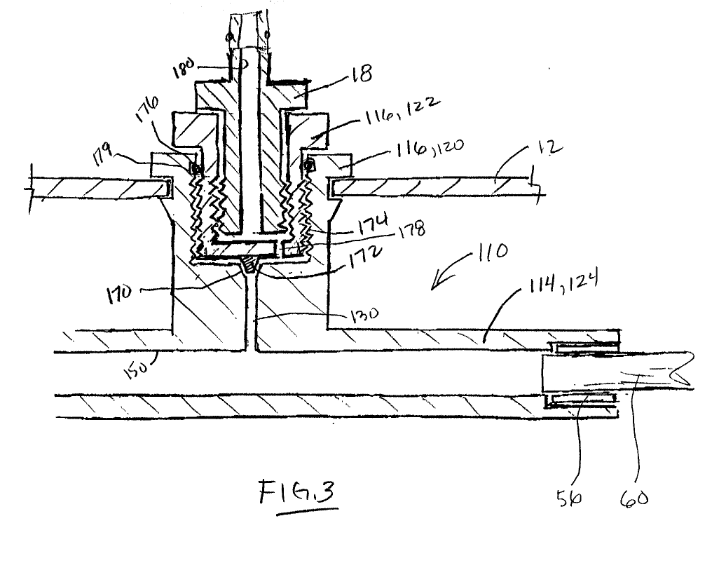

### The Embodiment of FIG. 3

Turning now to FIG. 3, an alternative embodiment of the valve assembly of the present invention is shown and generally designated by the numeral 110. Assembly 110 includes a Tee-fitting 114 and a rotary valve 116.

The assembly 110 is similar to the assembly 10 in many respects, with the primary difference being in the construction of the valve 116. The valve 116 has a fixed portion 120, which again is integrally formed with the body 124 of Tee-fitting 114. The valve member 116 includes a rotatable portion 122. The fixed valve portion 120 has an annular tapered valve seat 170 defined thereon. The rotatable valve portion 122 has a complementary tapered valve face 172 defined thereon. A threaded connection 174 between the fixed portion 120 and the rotatable portion 122 causes the tapered valve face 172 to move axially, that is parallel to axis 32, relative to the tapered valve seat 170, when the rotatable valve portion 122 is rotated relative to the fixed valve portion 120. An O-ring seal 176 received in groove 179 seals between the rotatable valve member 122 and the fixed valve member 120.

In FIG. 3, the valve member 116 is in a partially open position, wherein the valve face 172 is spaced from the valve seat 170 thus allowing fluid from the bore 150 of fitting 114 to flow through the third opening 130 past the valve seat 170 and through a port 178 which is communicated with the bore 180 of quick connect member 18. It will be appreciated that the rotatable valve portion 122 can be rotated so as to move the valve face 172 further away from valve seat 170 to further open the valve member 116, or the rotatable valve member 122 can be moved downward until the valve face 172 sealingly engages tapered valve seat 170 so as to fully close the valve member 116. Thus, the valve 116 serves as both a metering valve and a shut-off valve.

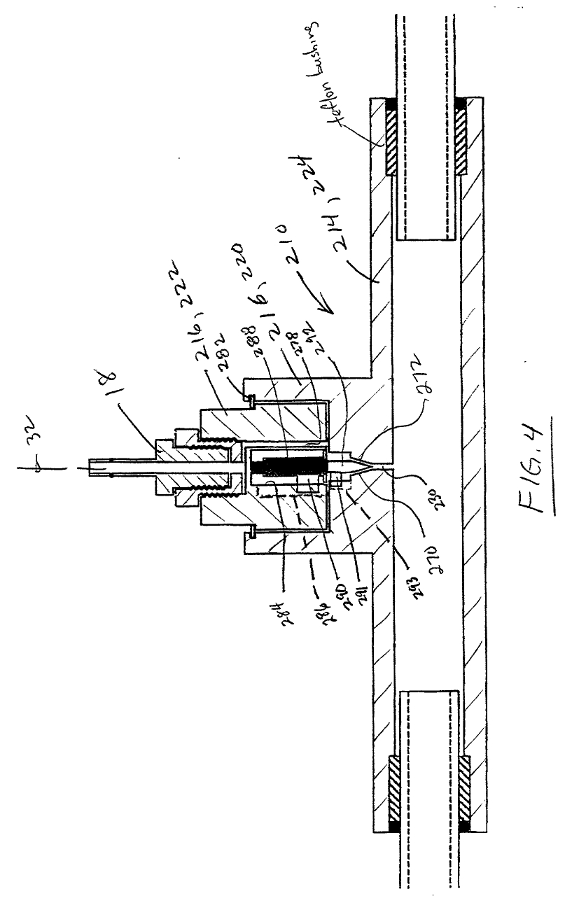

### The Embodiment of FIGS. 4, 6 and 7

In FIG. 4, still another embodiment of the valve assembly is generally designated by the numeral 210. Valve assembly 210 includes a Tee-fitting 214, and a rotary valve member 216. The valve member 216 has a fixed portion 220 and a rotatable portion 222. The fixed portion 220 is integrally formed with the body 224 of Tee-fitting 214.

The rotatable portion 222 is held axially in place relative to the fixed valve portion 220 by a lock ring 282.

Rotatable member 222 has a threaded bore 284. The female thread 284 is engaged with a male thread 286 of a needle valve 292. Needle valve 292 has a tapered valve face 272 defined thereon which is complementary to a tapered valve seat 270 defined in the fixed valve portion 220 and communicated with the third opening 230 of Tee-fitting 214.

A tab 291 extends from needle valve 292 and is received within axial slot 293 so that needle valve 292 can move axially, but not rotationally relative to fixed valve portion 220.

Thus, upon rotation of the rotatable valve member 222, the needle valve member 292 will move either upward or downward so as to move the valve face 272 either further away from or closer to the valve seat 270.

FIG. 6 is an enlarged view of the needle valve 292.

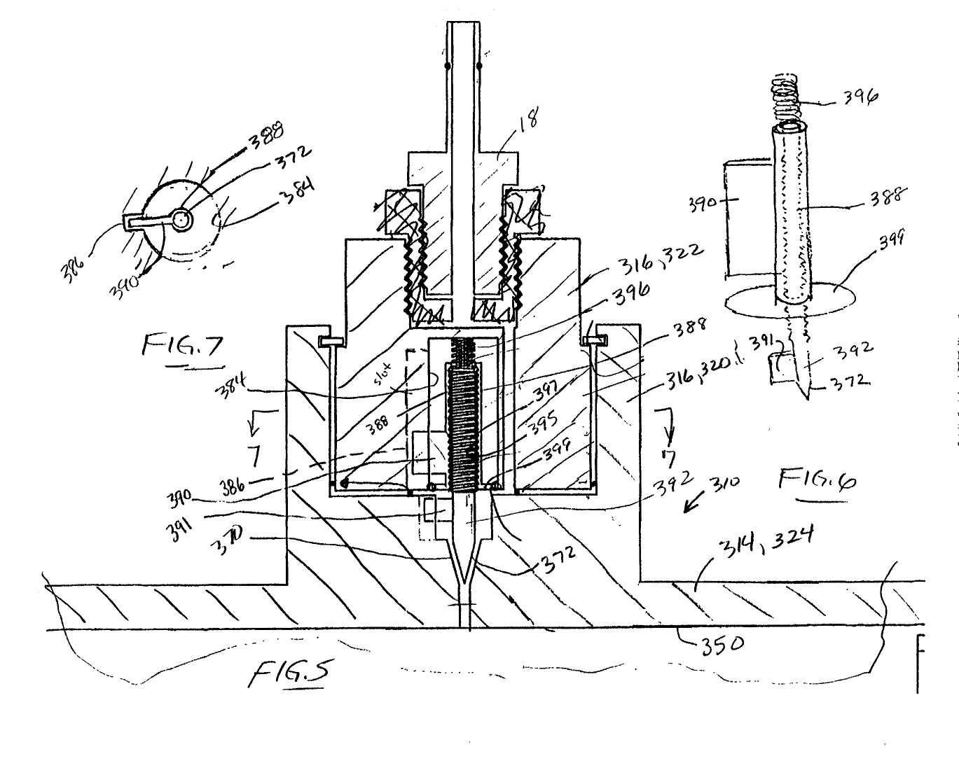

FIG. 7 is a somewhat schematic sectioned view taken along lines 7-7 of FIG. 4, showing how the tab 291 is received within the axial slot 293.

### The Embodiment of FIG. 8

FIG. 8 is a somewhat schematic cross section elevation view of a manifold assembly 800 contained within a housing 802 which is designed to be mounted upon a wall or the like of a building structure, in a manner analogous to that of the wall mounted housings and conduit structures generally described in U.S. Pat. No. 6,197,197, the details of which are incorporated herein by reference.

In the manifold assembly 800, a plurality of the valve assemblies including Tee-fittings and rotary valve members of the present invention, are assembled together to form the manifold 800. For example, a plurality of the Tee-fittings 10 of FIG. 1 may be utilized, and the same are designated as 10A, 10B, 10C, 10D and 10E in FIG. 8. Those assemblies 10 are shown mounted in a mounting plate 12. Each of those assemblies carries first quick connect parts 18A, 18B, 18C, 18D and 18E, respectively. Each of those quick connect parts is analogous to the quick 4 connect member 18 of FIG. 1.

Each of the pipe fittings 10A-E as mounted on mounting plate within housing 802 may be described as being fixed relative to a ground surface.

A plurality of complementary female quick connect parts 804A, 804B, 804C, 804D and 804E are shown connected to their complementary male quick connect parts 18A-18E, respectively.

A plurality of adaptor members 806A-806E are in turn connected to the female quick connect parts 18A-18E, respectively. The adaptors 806A-806E are mounted on a second mounting plate 808, so that all of the adaptors 806 and their connected female quick connect parts 804 may be attached or detached as a unit from the assemblies 10 and their male quick connect parts 18. Each of the adaptors 806A-806E, in turn, is connected to a further quick connect member 810A-810E. The further quick connect members 810A-810E will typically be the quick connects that are to be utilized to connect to specific healthcare equipment, such as for example, dialysis machines proprietary to various manufacturers as described in the above referenced U.S. Pat. No. 6,197,197, the details of which are incorporated herein by reference.

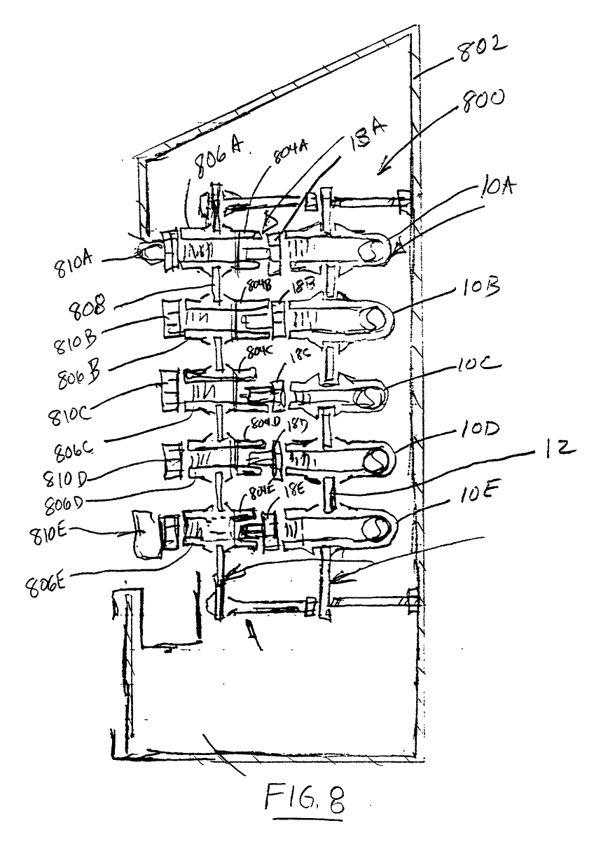

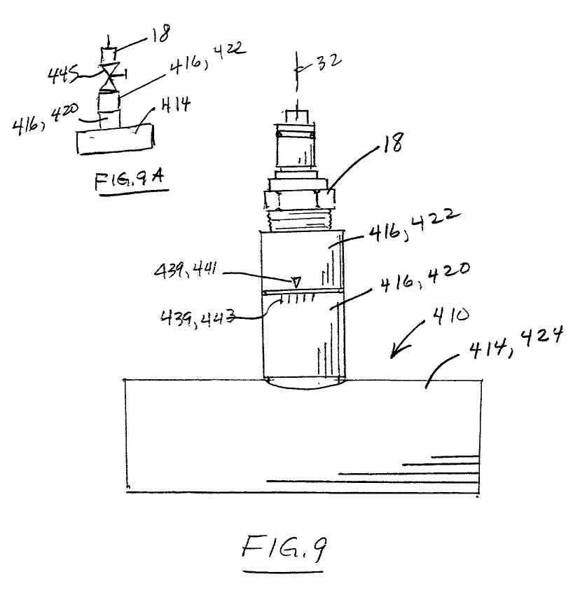

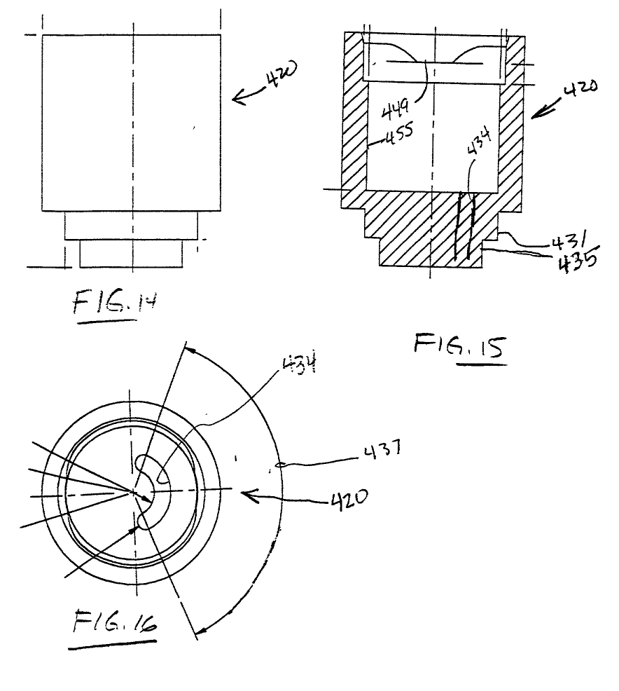

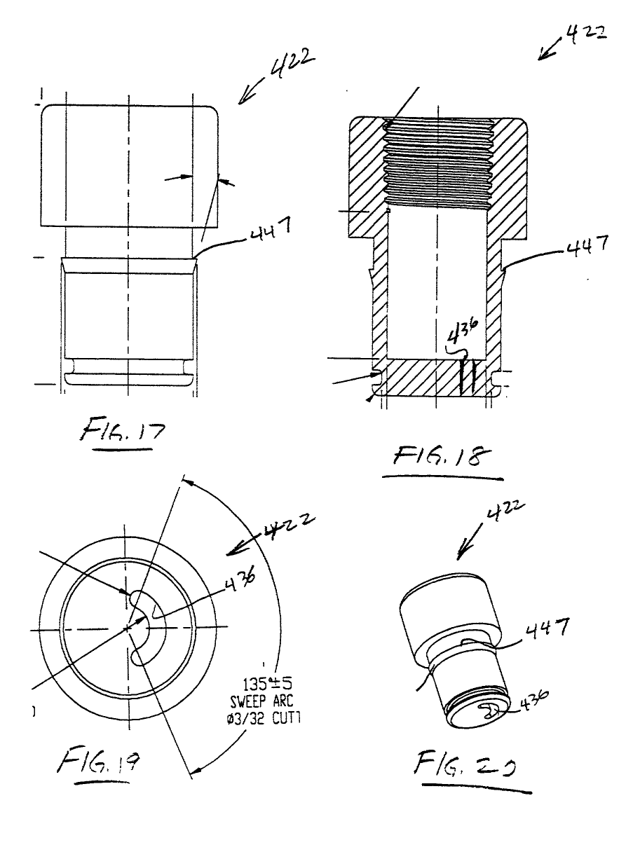

### The Embodiment of FIGS. 9-20

Referring now to FIG. 9, a fifth embodiment of the valve assembly of the present invention is generally designated by the numeral 410 and includes a Tee-fitting 414 and a rotary valve member 416. The Tee-fitting 414 includes a cylindrical body 424. The rotary valve 416 includes a fixed part 420 and a rotatable part 422. A male quick connect member 18 is shown connected to the rotatable part 422 of rotary valve 416.

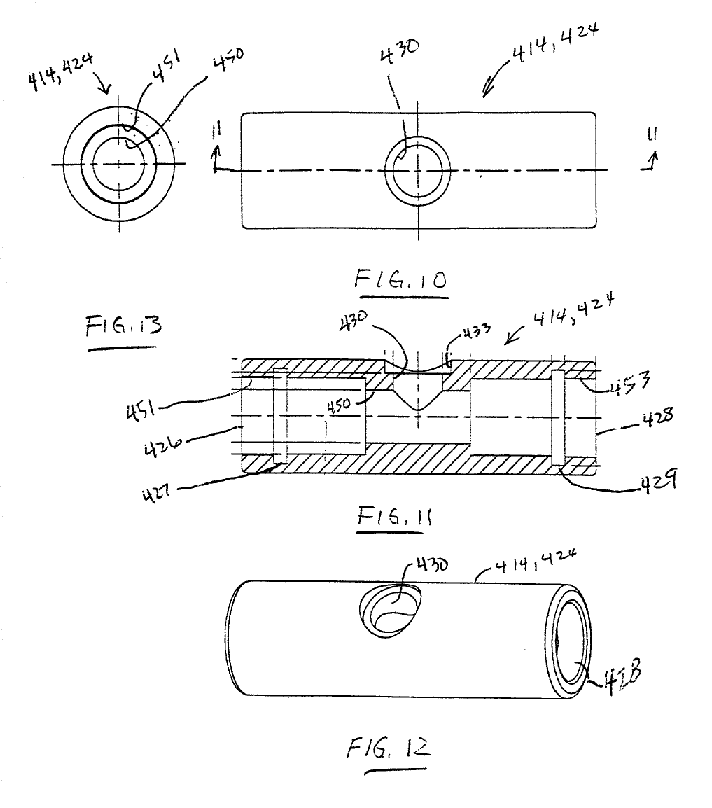

The details of construction of Tee-fitting 414 are shown in FIGS. 10-13. The details of construction of fixed valve part 420 are shown in FIGS. 14-16. The details of construction of rotatable valve part 422 are shown in FIGS. 17-20.

The Tee-fitting 414 includes a cylindrical body 424. A bore 450 through body 424 and first and second smooth counter bores 451 and 453 define the first and second openings 426 and 428 of the fitting 414. O-ring grooves 427 and 429 are defined in counter bores 451 and 453 for receipt of O-rings therein.

Thus, as shown on the left end of FIG. 11, joints of pipe like pipe 60 can be closely received within the counter bore 451 and will be sealingly engaged by the O-rings 458 contained in grooves 427. Thus, the pipe such as 60 can be said to be slip fit within the counter bores 451 and 453.

Thus, the O-ring 458 may be described as being located a first distance 459 past the end opening 426 within the counter bore 427, and the pipe 60 can be described as extending into the counter bore 451 a second distance 461 exceeding the first distance 459 by an amount sufficient to accommodate thermal expansion and contraction of the pipe 60. Thus, if fittings like Tee-fitting 414 are assembled in a manifold and fixed to a ground surface, such as shown in FIG. 8, and if all of the pipe connections thereto are arranged as shown in FIG. 11, then thermal expansion and contraction of the piping system will be accommodated by the permitted movement of the pipe sections 60 within their respective bores of the fittings to which they are connected.

Tee-fitting 414 further has a third side opening 430 defined therein communicated with the bore 450.

The details of construction of the fixed valve part 420 are seen in FIGS. 14-16. Fixed valve part 420 has a shoulder 431 which will be received within a counter bore 433 of fitting body 424, and a reduced diameter shoulder 435 will be received within the third opening 430.

The fixed valve portion 420 will preferably be permanently attached to Tee-fitting 414 by any suitable fashion such as glue or solvent welding.

As best seen in FIGS. 15 and 16, a first port 434 defined through the lower end of fixed valve part 420 is an arc shaped port which subtends an angle 437 about axis 32 as best seen in FIG. 16.

As seen in FIGS. 18-20, the rotatable valve part 422 has a second arc shaped port 436 defined therein of similar size and shape to first arc shaped port 434.

The first and second arc shaped ports 434 and 436 are radially offset from axis 32 by the same distance, so that as the rotatable valve part 422 is rotated relative to the fixed valve part 420, varying amounts of the first and second arc shaped ports 434 and 436 will overlap. The amount of overlap can be anywhere from nothing to a complete overlap, or anything in between.

As shown in FIG. 9, visual indicia 439 such as pointer 441 and markers 443 are provided to provide a visual indication of the degree of overlap between arc shaped ports 434 and 436.

The arc shaped ports 434 and 436 provide an improved metering function as compared to the circular ports 34 and 36 of the embodiment of FIG. 1.

It is noted that in the embodiment illustrated in FIGS. 9-20, there is no seal provided between arc shaped ports 434 and 436, and thus, even when the ports 434 and 436 are completely out of registry with each other, they will not serve to completely shut off the flow of liquid therebetween. If it is desired to have a shutoff valve, then as schematically illustrated in FIG. 9A, a shutoff valve 445 can be placed in-line with the rotary valve 416.

A seal analogous to the O-ring seal 38 of FIG. 1 could be provided around the arc shaped port 436 if desired.

As seen in FIGS. 17, 18 and 20, the rotary valve part 422 has a tapered annular shoulder 447 defined thereon.

Fixed valve part 420 has a resilient locking member 449 defined thereon which is complementary to the annular shoulder 447, thus when the rotatable valve part 422 has its lower end inserted downward into a bore 455 of fixed valve part 420, the shoulder 447 moves below locking member 449 and snaps in place as it moves past locking member 449. This provides a snap fit connection between the annular shoulder 447 and the resilient locking member 449 which locks the fixed and rotary valve portions 420 and 422, respectively, together.

Thus, it is seen that the apparatus of the present invention readily achieves the ends and advantages mentioned as well as those inherent therein. While certain preferred embodiments of the invention have been illustrated and described for purposes of the present disclosure, numerous changes in the arrangement and construction of parts may be made by those skilled in the art, which changes are encompassed within the scope and spirit of the present invention as defined by the appended claims.

What is claimed is:

1. A valve assembly apparatus comprising:
a tee-fitting having first and second end openings, and a third side opening and;
a rotary valve having a rotational axis extending laterally relative to the end openings, the rotary valve including a fixed portion connected to the third side opening and fixed relative to the tee-fitting, and a rotatable portion which is rotatable about said rotational axis between an open position and a closed position relative to the fixed portion.

2. The apparatus of claim 1, further comprising:
a quick connect coupling, connected to the rotatable portion of the rotary valve.

3. The apparatus of claim 1, wherein:
the rotary valve is a metering valve.

4. The apparatus of claim 1, wherein:
the fixed portion of the rotary valve has a first port defined therein;
the rotatable portion of the rotary valve has a second port therein; and
wherein the first and second ports are in registry with each other when the rotatable portion is in its open position, and the first and second ports are out of registry with each other when the rotatable portion is in its closed position.

5. The apparatus of claim 4, wherein the rotary valve includes a seal positioned to provide fluid isolation of the first port from the second port when the rotatable portion is in its closed position.

6. The apparatus of claim 4, wherein:
the first and second ports are each radially offset from the rotational axis.

7. The apparatus of claim 6, wherein:
the rotatable portion can be moved to a plurality of intermediate positions wherein the first and second ports are in partial registry to varying degrees, so that the rotary valve can selectively meter flow through the third side opening.

8. The apparatus of claim 1, further comprising:
the fixed portion of the rotary valve having a seat defined therein;
a needle valve having a needle valve face complementary to the seat; and
a threaded screw connection between the needle valve and the rotatable member, so that upon rotation of the rotatable member in a first direction the needle valve is moved toward the seat, and upon rotation of the rotatable member in a second direction the needle valve is moved away from the seat.

9. The apparatus of claim 1, further comprising:
one of the fixed portion and the rotatable portion having a tapered valve seat defined thereon, and the other having a complementary tapered valve face defined thereon; and
a threaded connection between the fixed portion and the rotatable portion of the rotary valve, so that upon rotation of the rotatable portion the valve face moves axially relative to the valve seat.

10. The apparatus of claim 1, further comprising:
complementary first and second abutment surfaces defined on the fixed and rotatable portions, respectively, the abutment surfaces abutting each other to terminate relative rotational motion between the fixed and rotatable portions at a position corresponding to at least one of said open and closed positions.

11. A quick connect valve apparatus, comprising:
first and second valve parts rotatably connected together so that the second valve part is rotatable about a rotational axis relative to the first valve part;
first and second ports defined in the first and second valve parts, respectively, each of the ports being radially offset from the rotational axis, so that rotational movement of the second valve part relative to the first valve part moves the second port into and out of registry with the first port; and
a quick connect fitting attached to the second valve part.

12. A fitting and valve assembly, comprising:
a tee-fitting having first and second end openings, and a third side opening;
a fixed valve part attached to the third side opening;
a rotatable valve part, rotatably connected to the fixed valve part so that the rotatable valve part rotates about a valve axis relative to the fixed valve part;
first and second ports defined in the fixed and rotatable valve parts, respectively, each of the ports being radially offset from the valve axis, so that rotational movement of the rotatable valve part relative to the fixed valve part moves the second port into and out of registry with the first port.

13. The assembly of claim 12, wherein:
the first and second ports can be in a position of partial registry so that a fluid flow therethrough is metered.
